(19) United States
(12) Patent Application Publication
(10) Pub. No.: US 2017/0163496 A1
(43) Pub. Date: Jun. 8, 2017

(54) Harq Optimization for TDM Mode

(71) Applicant: Nokia Solutions and Networks Oy, Espoo (FI)

(72) Inventors: Maciej Januszewski, Pila (PL); Grigory Serebryakov, Nizhny Novgorod (RU); Karri Markus Ranta-Aho, Esoii (FI); Alexey Trushanin, Nizhny Novgorod (RU)

(21) Appl. No.: 15/127,784

(22) PCT Filed: Mar. 21, 2014
(86) PCT No.: PCT/EP2014/055720

§ 371 Date: Sep. 20, 2016

(51) Int. Cl. H04J 3/00

(52) U.S. Cl. CPC H04L 41/5051

(57) ABSTRACT

It is provided a method, comprising monitoring if a sent packet is acknowledged as correctly received; checking, if the sent packet is not acknowledged as correctly received, if retransmitting the sent packet at a time interval determined for retransmission is admitted; informing, if the retransmitting at the determined time interval is not admitted, that the sent packet is not acknowledged as correctly received.

### FIELD OF THE INVENTION

The present invention relates to an apparatus, a method, and a computer program product related to data communication. More particularly, the present invention relates to an apparatus, a method, and a computer program product related to HARQ.

### BACKGROUND OF THE INVENTION

### Abbreviations

3GPP 3^{rd} Generation Partnership Project
ACK Acknowledge
CRC Cyclic Redundancy Check
DPCCH Dedicated Physical Control Channel
eNB Evolved Node B
E-AGCH Enhanced Absolute Grant Channel
E-DCH Enhanced Dedicated Channel
E-DPDCH Enhanced Dedicated Physical Data Channel
E-HICH E-DCH HARQ Indicator Channel
E-RGCH Enhanced Relative Grant Channel
E-RNTI E-DCH RNTI
EUL Enhanced Uplink
E-UTRAN Evolved UTRAN
FDD Frequency Division Duplex
HARQ Hybrid Automatic Repeat Request
HS-SCCH High-Speed Shared Control Channel
HSDPA High Speed Downlink Packet Access
HSUPA High Speed Uplink Packet Access
LTE• Long Term Evolution
LTE-A• Long Term Evolution-Advanced
NB, NodeB Base Station in 3GPP terminology
NBAP NodeB Application Part
OSI Open Systems Interconnection
OVSF Orthogonal Variable Spreading Factor
RNC Radio Network Controller
RNTI Radio Network Temporary Identifier
RoT Rise over Thermal
RRC Radio Resource Control
RSN Retransmission Sequence Number
SI Scheduling Information
TDM Time Division Multiplex
TR Technical Report
TTI Transmission Timing Interval
UE User Equipment
UL Uplink
UMTS Universal Mobile Telecommunication System
UTRAN UMTS RAN
WCDMA Wideband Code Division Multiplex Access
WiFi• Wireless Fidelity

Time division multiplexing (TDM) operation in High Speed Uplink Packet Access (HSUPA) is one of the topics considered within the Work Item on Further Enhancements to Enhanced Uplink being held in 3GPP RAN1 (e.g. RP-132078: “New Work Item proposal: Further EUL enhancements”, Ericsson™, RAN #62). The TDM scheduling refers to a situation in which one or several selected User Equipment entities (UEs) in a given cell consume most of the Rise over the Thermal (RoT) budget by transmitting with a high data rate for the duration of a scheduling period (which may last from several Transmission Time Intervals (TTIs) to several tens/hundreds of TTIs), while at the same time other UEs either stop their transmission or their transmission consumes significantly less power resources. Since it has been proven that uplink TDM operation can bring substantial performance gains several standard changes have been proposed within the Work Item in order to facilitate efficient TDM operation in HSUPA.

One of the proposals (originally made by NSN™, see PCT/EP2013/059565) is as follows:

TDM scheduling can be realized in the conventional 3GPP WCDMA system. However, the signalling overhead is significant. It is assumed that in the TDM mode the base station (NodeB) has to nominate one UE which will transmit for the next period, while another UE transmitting in the previous period has to be informed that it has to stop the transmission. For that 2 commands have to be issued:
1. E-AGCH with either ZERO, INACTIVE or very low Absolute Grant Value addressing the UE transmitting in the previous period
2. E-AGCH with Absolute Grant Value for a UE nominated to transmit in the next period. Typically, in TDM mode, the absolute grant value is relatively high.

In this example it is assumed that further UEs in the cell are not transmitting data or transmit low data rates.

After sending the ZERO-grant to currently transmitting UE one TTI is lost (no UE transmitting with high datarate in the next TTI) before the next UE receives and applies new absolute grant because only one absolute grant may be transmitted per TTI. This reduces gains coming from the TDM scheduling.

According to the proposal, the signalling overhead is reduced and/or the problem of not utilized TTIs in case of TDM scheduling is solved.

Conventionally, in HSUPA, all active UEs monitor the E-AGCH channel. When a transmission occurs each UE tries to decode the grant message by performing a CRC check with its E-RNTI, which is associated uniquely to each UE in the cell. If a UE successfully decodes the grant it starts the grant update procedure (set their Serving Grant to the value indicated in the grant message).

According to the proposal, all other UEs who receive an E-AGCH transmission which is not intended for them (the CRC check fails) automatically set their Serving Grants to zero. This way a single E-AGCH command would provide an absolute grant for one UE and at the same time silence other UEs in a cell.

According to the proposal, the E-AGCH for TDM UEs may be transmitted using dedicated OVSF code. This ensures that grant signalling to legacy UEs does not interfere with grant signalling for TDM.

### SUMMARY OF THE INVENTION

It is an object of the present invention to improve the prior art.

According to a first aspect of the invention, there is provided an apparatus, comprising monitoring means adapted to monitor if a sent packet is acknowledged as correctly received; checking means adapted to check, if the sent packet is not acknowledged as correctly received, if retransmitting the sent packet at a time interval determined for retransmission is admitted; informing means adapted to inform, if the retransmitting at the determined time interval is not admitted, that the sent packet is not acknowledged as correctly received.

In the apparatus, the informing means may be adapted to inform by signaling scheduling information.

According to a second aspect of the invention, there is provided an apparatus, comprising monitoring means adapted to monitor if a sent packet is acknowledged as correctly received; checking means adapted to check, if the sent packet is not acknowledged as correctly received, if retransmitting the sent packet at a time interval determined for retransmission is admitted; discarding means adapted to discard the packet if the retransmitting at the determined time interval is not admitted irrespective of an actual number of retransmissions of the sent packet.

In the apparatus, the discarding means may be adapted to set, if the retransmitting at the determined time interval is not admitted, a number of retransmissions of the sent packet to a predefined maximum number.

The apparatus may further comprise flushing means adapted to flush a buffer in which the sent packet is stored.

The apparatus according to any of the first and second aspects may further comprise preventing means adapted to prevent a transmitting means from retransmitting the sent packet at the determined time interval if the retransmitting at the determined time interval is not admitted.

The apparatus according to any of the first and second aspects may further comprise instructing means adapted to instruct the transmitting means, if the sent packet is not acknowledged as correctly received, to retransmit the sent packet; determining means adapted to determine if a condition is established; inhibiting means adapted to inhibit the preventing means from preventing if the condition is not established and to inhibit the instructing means from instructing if the condition is established.

In the apparatus according to any of the first and second aspects, the condition may comprise that an instruction is received to inhibit the instructing means.

In the apparatus according to any of the first and second aspects, the condition may comprise that the apparatus is in a soft handover process.

According to a third aspect of the invention, there is provided an apparatus, comprising monitoring processor adapted to monitor if a sent packet is acknowledged as correctly received; checking processor adapted to check, if the sent packet is not acknowledged as correctly received, if retransmitting the sent packet at a time interval determined for retransmission is admitted; informing processor adapted to inform, if the retransmitting at the determined time interval is not admitted, that the sent packet is not acknowledged as correctly received.

In the apparatus, the informing processor may be adapted to inform by signaling scheduling information.

According to a fourth aspect of the invention, there is provided an apparatus, comprising monitoring processor adapted to monitor if a sent packet is acknowledged as correctly received; checking processor adapted to check, if the sent packet is not acknowledged as correctly received, if retransmitting the sent packet at a time interval determined for retransmission is admitted; discarding processor adapted to discard the packet if the retransmitting at the determined time interval is not admitted irrespective of an actual number of retransmissions of the sent packet.

In the apparatus, the discarding processor may be adapted to set, if the retransmitting at the determined time interval is not admitted, a number of retransmissions of the sent packet to a predefined maximum number.

The apparatus may further comprise flushing processor adapted to flush a buffer in which the sent packet is stored.

The apparatus according to any of the third and fourth aspects may further comprise preventing processor adapted to prevent a transmitting processor from retransmitting the sent packet at the determined time interval if the retransmitting at the determined time interval is not admitted.

The apparatus according to any of the third and fourth aspects may further comprise instructing processor adapted to instruct the transmitting processor, if the sent packet is not acknowledged as correctly received, to retransmit the sent packet; determining processor adapted to determine if a condition is established; inhibiting processor adapted to inhibit the preventing processor from preventing if the condition is not established and to inhibit the instructing processor from instructing if the condition is established.

In the apparatus according to any of the third and fourth aspects, the condition may comprise that an instruction is received to inhibit the instructing processor.

In the apparatus according to any of the third and fourth aspects, the condition may comprise that the apparatus is in a soft handover process.

According to a fifth aspect of the invention, there is provided an apparatus, comprising monitoring means adapted to monitor if a packet from a sender was received incorrectly; checking means adapted to check if a message is received that the packet is not acknowledged as to be correctly received; preventing means adapted to prevent, if the message is not received, a granting means from granting a time interval to the sender just for retransmitting the packet.

In the apparatus, the message may be received via signaling.

The apparatus may further comprise determining means adapted to determine if a condition is established; inhibiting means adapted to inhibit the preventing means from preventing if the condition is not established.

The apparatus may further comprise handover determining means adapted to determine if the sender is in a soft handover process; wherein the condition may be established if it is determined that the sender is in the soft handover process.

The apparatus may further comprise instructing means adapted to instruct the sender to at least one of inform if the packet is to be retransmitted although the time interval for the retransmission is not granted, and discard the packet if retransmitting at a predetermined time interval is not admitted irrespective of an actual number of retransmissions of the packet.

In the apparatus, the instructing means may be adapted to instruct by a shared control channel command.

In the apparatus, the condition may be established if an information is received that the sender will provide the message.

According to a sixth aspect of the invention, there is provided an apparatus, comprising monitoring processor adapted to monitor if a packet from a sender was received incorrectly; checking processor adapted to check if a message is received that the packet is not acknowledged as to be correctly received; preventing processor adapted to prevent, if the message is not received, a granting processor from granting a time interval to the sender just for retransmitting the packet.

In the apparatus, the message may be received via signaling.

The apparatus may further comprise determining processor adapted to determine if a condition is established; inhibiting processor adapted to inhibit the preventing processor from preventing if the condition is not established.

The apparatus may further comprise handover determining processor adapted to determine if the sender is in a soft handover process; wherein the condition may be established if it is determined that the sender is in the soft handover process.

The apparatus may further comprise instructing processor adapted to instruct the sender to at least one of inform if the packet is to be retransmitted although the time interval for the retransmission is not granted, and discard the packet if retransmitting at a predetermined time interval is not admitted irrespective of an actual number of retransmissions of the packet.

In the apparatus, the instructing processor may be adapted to instruct by a shared control channel command.

In the apparatus, the condition may be established if an information is received that the sender will provide the message.

According to a seventh aspect of the invention, there is provided an apparatus, comprising deciding means adapted to decide on a repeat mode out of a group of repeat modes a terminal has to perform for a sent packet for which the terminal does not receive an acknowledgment, wherein the group of repeat modes comprises at least two of
retransmitting the packet at a predetermined time interval irrespective of whether the predetermined time interval is granted to the terminal,
informing a base station that the acknowledgment was not received, and
discarding the packet; and
   instructing means adapted to instruct the terminal to perform the decided repeat mode.

The apparatus may further comprise informing means adapted to inform the base station on the decided repeat mode.

In the apparatus, the informing means may be adapted to inform the base station over a base station application part.

In the apparatus, the instructing means may be adapted to instruct the terminal by a radio resource control layer message.

In the apparatus, the deciding means may be adapted to decide based on at least one of a handover status of the terminal, a service type used by the terminal, a cell throughput of the base station, and a transmission delay between the terminal and the base station.

According to an eighth aspect of the invention, there is provided an apparatus, comprising deciding processor adapted to decide on a repeat mode out of a group of repeat modes a terminal has to perform for a sent packet for which the terminal does not receive an acknowledgment, wherein the group of repeat modes comprises at least two of
retransmitting the packet at a predetermined time interval irrespective of whether the predetermined time interval is granted to the terminal,
informing a base station that the acknowledgment was not received, and
discarding the packet; and
   instructing processor adapted to instruct the terminal to perform the decided repeat mode.

The apparatus may further comprise informing processor adapted to inform the base station on the decided repeat mode.

In the apparatus, the informing processor may be adapted to inform the base station over a base station application part.

In the apparatus, the instructing processor may be adapted to instruct the terminal by a radio resource control layer message.

In the apparatus, the deciding processor may be adapted to decide based on at least one of a handover status of the terminal, a service type used by the terminal, a cell throughput of the base station, and a transmission delay between the terminal and the base station.

According to a ninth aspect of the invention, there is provided a method, comprising monitoring if a sent packet is acknowledged as correctly received; checking, if the sent packet is not acknowledged as correctly received, if retransmitting the sent packet at a time interval determined for retransmission is admitted; informing, if the retransmitting at the determined time interval is not admitted, that the sent packet is not acknowledged as correctly received.

In the method, the informing may be made by signaling scheduling information.

According to a tenth aspect of the invention, there is provided a method, comprising monitoring if a sent packet is acknowledged as correctly received; checking, if the sent packet is not acknowledged as correctly received, if retransmitting the sent packet at a time interval determined for retransmission is admitted; discarding the packet if the retransmitting at the determined time interval is not admitted irrespective of an actual number of retransmissions of the sent packet.

In the method, the discarding may comprise setting, if the retransmitting at the determined time interval is not admitted, a number of retransmissions of the sent packet to a predefined maximum number.

The method may further comprise flushing a buffer in which the sent packet is stored.

The method according to any of the ninth and tenth aspects may further comprise preventing the retransmitting of the sent packet at the determined time interval if the retransmitting at the determined time interval is not admitted.

The method according to any of the ninth and tenth aspects may further comprise instructing, if the sent packet is not acknowledged as correctly received, to retransmit the sent packet; determining if a condition is established; inhibiting the preventing if the condition is not established, and inhibiting the instructing if the condition is established.

In the method according to any of the ninth and tenth aspects, the condition may comprise that an instruction is received to inhibit the instructing.

In the method according to any of the ninth and tenth aspects, the condition may comprise that an apparatus performing the method is in a soft handover process.

According to an eleventh aspect of the invention, there is provided a method, comprising monitoring if a packet from a sender was received incorrectly; checking if a message is received that the packet is not acknowledged as to be correctly received; preventing, if the message is not received, granting a time interval to the sender just for retransmitting the packet.

In the method, the message may be received via signaling.

The method may further comprise determining if a condition is established; inhibiting the preventing if the condition is not established.

The method may further comprise determining if the sender is in a soft handover process; wherein the condition may be established if it is determined that the sender is in the soft handover process.

The method may further comprise instructing the sender to at least one of inform if the packet is to be retransmitted although the time interval for the retransmission is not granted, and discard the packet if retransmitting at a predetermined time interval is not admitted irrespective of an actual number of retransmissions of the packet.

In the method, the instructing may be performed by a shared control channel command.

In the method, the condition may be established if an information is received that the sender will provide the message.

According to a twelfth aspect of the invention, there is provided a method, comprising deciding on a repeat mode out of a group of repeat modes a terminal has to perform for a sent packet for which the terminal does not receive an acknowledgment, wherein the group of repeat modes comprises at least two of
retransmitting the packet at a predetermined time interval irrespective of whether the predetermined time interval is granted to the terminal,
informing a base station that the acknowledgment was not received, and
discarding the packet; and
   instructing the terminal to perform the decided repeat mode.

The method may further comprise informing the base station on the decided repeat mode.

In the method, the informing of the base station on the decided repeat mode may be made over a base station application part.

In the method, the instructing of the terminal may be made by a radio resource control layer message.

In the method, the deciding may be made based on at least one of a handover status of the terminal, a service type used by the terminal, a cell throughput of the base station, and a transmission delay between the terminal and the base station.

Each of the methods of the ninth to twelfth aspects may be a method of an automatic repeat request procedure.

According to a thirteenth aspect of the invention, there is provided a computer program product comprising a set of instructions which, when executed on an apparatus, is configured to cause the apparatus to carry out the method according to any one of the ninth to twelfth aspects. The computer program product may be embodied as a computer readable medium or directly loadable into a computer.

According to some embodiments of the invention, at least one of the following advantages may be achieved:
HARQ design is improved;
TDM performance is improved;
the invention may be adopted in the presence of legacy UEs.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows conventional TTI scheduling;

FIG. 2 shows an apparatus according to an embodiment of the invention;

FIG. 3 shows a method according to an embodiment of the invention;

FIG. 4 shows an apparatus according to an embodiment of the invention;

FIG. 5 shows a method according to an embodiment of the invention; and

FIG. 6 shows an apparatus according to an embodiment of the invention;

FIG. 7 shows a method according to an embodiment of the invention;

FIG. 8 shows an apparatus according to an embodiment of the invention;

FIG. 9 shows a method according to an embodiment of the invention; and

FIG. 10 shows an apparatus according to an embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

There are several other aspects of TDM operation that are still to be addressed. One of the remaining problems is the HARQ operation in the TDM mode. Embodiments of the invention improve HARQ mechanism design in order to provide better TDM performance.

In the TDM mode, UEs are scheduled in such a way that they take turns in transmitting the uplink data and their transmission do not interfere with each other. However, HARQ functionality in HSUPA dictates that the retransmission of unsuccessfully received packet should take place in the same HARQ process at a predefined time after the previous transmission (e.g. 8 TTIs after the initial transmissions in case of 2 ms TTI). A UE performs the retransmission automatically in the corresponding TTI if it does not receive a confirmation of correctly received packet.

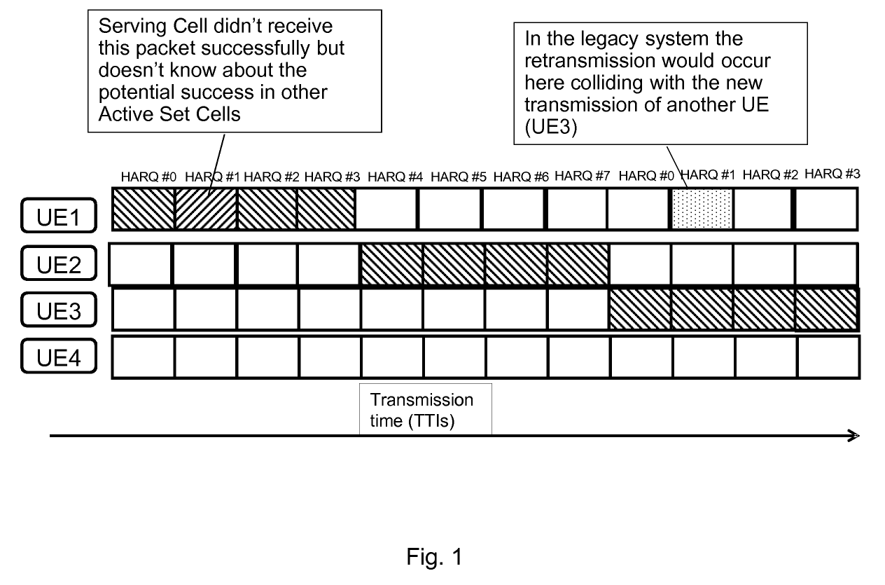

The confirmation (ACK) may be received either from the serving cell or another cell from the active set. When working in TDM fashion it is possible that, at the time of retransmission, another UE will have its turn of transmitting with a high data rate and consuming all or majority of the cell resources. In such a case both the new transmission and the retransmission would interfere strongly with each other and potentially neither of them would be successful. This scenario is depicted in FIG. 1.

FIG. 1 shows the conventional scheduling of TTIs over 3 UEs (no TTI is scheduled for the fourth UE (UE4)). Each box represents a TTI and its scheduling state for a respective UE. If the box is hashed it is scheduled for the UE, if it is blank it is not scheduled for the UE. If the box is dotted, it is not scheduled for the UE to transmit a new packet. Every 8 TTIs, the corresponding HARQ processes are repeated.

UE1 transmits in TTIs #0 to #3, corresponding to HARQ processes #0 to #3), UE2 transmits in TTIs #4 to 7, corresponding to HARQ processes #4 to #7. UE #3 transmits in TTIs #8 to #11, corresponding to HARQ processes #0 to #3. At each TTI, only one of UE1 to UE3 transmits initially.

However, the transmission of UE1 in TTI #1 fails (indicated by a different direction of the hashing). Accordingly, UE1 repeats its transmission in TTI #9, which is the TTI of the same HARQ process #1. Hence, in TTI #9, there are two simultaneous transmissions: the initial transmission of UE3 and the re-transmission of UE1. Since both transmissions occur with high power, they may strongly interfere with each other.

This problem has been already identified in 3GPP TR 25.700 “Study of Further Enhanced Uplink (EUL) enhancements”, v12.0.0. It was mentioned that in such a scenario the scheduler could either prioritize initial transmissions or retransmissions.

Prioritizing of retransmissions means that, in the above example, the scheduler prepares for a retransmission and deactivates the transmission of other UEs (UE3 in this case) for a TTI when it expects a retransmission because the original transmission was not received correctly by that cell.

However, if the UE1 is in Soft Handover (which may happen e.g. in at least 30% of cases) the serving cell does not know if the packet was received by one of the cells in the active set of UE1. If it was successfully received by one of these cells there is no need for a retransmission. Hence, the serving cell does not know whether it should prepare for a retransmission.

As one option, the serving cell could prepare for a retransmission irrespectively of the outcome of the reception at the other cells of the active set but that would lead to a waste of resources in case of reception success in at least one of the cells of the active set.

On the other hand, prioritizing new transmissions would mean that a UE would not perform a retransmission if it had received a “Zero Grant” after the first transmission. Instead it would keep the packet to be retransmitted in the HARQ buffer until it again receives an Absolute Serving grant valid for the given HARQ process.

As explained above, the serving cell does not always know whether or not there is a need of a retransmission. Hence, in a scenario prioritizing new transmissions, in soft handover operation the serving cell learns about the need of retransmission only when it actually takes place (UE sends a packet with the RSN corresponding to a retransmission). Accordingly, the scheduler does not know whether to keep on scheduling new UEs, or whether to come back to a UE which potentially has a retransmission to be performed. This may be of particular disadvantage if it is known from the prior scheduling information that the UE requiring a re-transmission does not have any new data to be scheduled. In this case, re-transmission may have to wait for a very long time.

According to embodiments of the invention, the base station (e.g. eNB or NB) gets informed by the UE if a retransmission is required, e.g. by signaling. One example of such signaling is signaling the scheduling information (SI). Accordingly, the base station may schedule a grant for the retransmission if needed and/or may not schedule a grant just for retransmission if not needed.

According to embodiments of the invention, on the UE side, one of the following procedures may be performed:

The UE monitors if a packet is not acknowledged as correctly received (ACK on E-HICH missing) by any of the cells from the active set and the UE's serving grant expired in the meantime or was set to “Zero Grant” or “inactive”. In addition, in some embodiments, UE may check if the predetermined maximum number of transmission attempts was not reached. Then, the UE does not retransmit automatically, as it would do in a legacy case. Instead, it may perform one of the following two routines:
1) The UE signals to the serving cell that a retransmission (and possibly also indication of which HARQ process) is needed. This signaling could be performed by sending the Scheduling Information (SI) message to the serving cell. The SI message could point to the given HARQ process by a timing association or it could explicitly contain information pointing to the HARQ process that awaits a retransmission.
2) The UE discards the packet. I.e., the UE does not foresee the packet for retransmitting any more. E.g., this may be done by setting the number of retransmissions to the maximum number of allowed retransmissions irrespective of the actual number of retransmissions. In this case, the respective higher layer application may decide how to proceed further with the packet which could not be transmitted successfully. Hence, the UE leaves it to the higher layer to decide whether or not to retransmit the packet if the Serving Grant was passed to another UE after the initial unsuccessful transmission. In addition, the UE may flush its HARQ buffer.

If the higher layer application decides that the packet is to be transmitted again, this will be handled by layers 1 and 2 in the same way as transmitting any other (new) packet.

The maximum number of retransmissions is a natural number such as 1, 2, 3, or more. For example, assume that the maximum number of retransmissions is 1. If the first transmission of a packet seems to fail from UE perspective (no ACK received) and there is no grant scheduled for retransmission, the UE does not retransmit the packet, but nevertheless the number of retransmissions will be set to 1.

Higher layer application is an application of layer 3 and above, preferably of layer 4 or above, wherein layers 1 to 3 are the physical layer, the data link layer, and the network layer of the OSI layer model, respectively.

Some embodiments of the invention comprise a mechanism of switching between the legacy HARQ operation (automatic retransmissions until ACK on E-HICH received or maximum number of retransmissions is reached) and one of the schemes described in 1) and 2). Each of the legacy HARQ operation and the operation according to one of the schemes described in 1) and 2) may also be denoted as a HARQ mode.

In some embodiments, the network (represented by e.g. the base station or a controller such as a RNC) may decide which HARQ mode will be performed by the UE. The network will instruct the UE on the decision, and the UE will obey this instruction.

For example, the RNC may decide on the HARQ mode as part of the RRC-layer configuration. The RNC sends an RRC message (as payload through NodeB) to the UE. The RNC may also inform the Node B with NBAP message of the UE's mode. Then the radio communication between the UE and the NodeB may be performed in the HARQ mode decided by the RNC.

In another example embodiment, NodeB takes the decision on the HARQ mode and signals it directly to the UE over the air. A typical way for the signaling would be to use shared control channel order such as an HS-SCCH order, similar to those used e.g. for activating and deactivating carriers when the UE is in multicarrier HSDPA mode.

In yet another example embodiment, NodeB may indicate the desired HARQ mode over NBAP to the RNC. This could be e.g. a NodeB capability indication telling the RNC whether the new mode is supported. Then, the RNC configures the UE such that it operates in the desired HARQ mode (e.g. by an RRC message).

The RNC may configure the HARQ mode for a single UE, for a group of UEs, or for all UEs.

In some embodiments, the UE may decide on the HARQ mode it will perform. The UE may inform the network on the decision.

In some embodiments, UE and network will decide independently from each other on the HARQ mode to be performed by the UE. In these embodiments, UE and network decide based on the same condition, which is known to both UE and network. Thus, signaling of the HARQ mode between the network and UE is not required.

An example condition to switch to one of the HARQ modes described in 1) and 2) may be that the UE is in soft handover, which is an example of a handover status. The UE may decide this based on the number of cells in the active set. Also, the network is aware if the UE is in soft handover. Another example condition is a certain service type the UE is using. This condition may be known to both UE and network, too.

The network may also decide based on different metrics that the network wants to optimize (e.g. delay, cell throughput, etc.).

Furthermore, the network may know if a UE is capable of working according to one of the HARQ modes described in 1) and 2). Thus, it may instruct only UEs capable of the HARQ modes described in 1) and 2) to operate according to one of these schemes but it may not instruct other UEs.

If the base station is aware that UE will send a request to schedule for a retransmission if needed (i.e., an information that ACK was not received for a packet, HARQ mode described in 1)), it may typically prioritize new transmissions.

Embodiments of the invention may solve all above identified problems of HARQ mechanism in TDM mode in HSUPA. The serving cell scheduler may prioritize retransmissions (e.g. for delay optimization) using the legacy HARQ mechanism—performing the retransmissions automatically. In order to maximally optimize the TDM performance, UE may not retransmit automatically. Then, in case of a soft handover operation, it may signal to the serving cell that a retransmission is pending, thus providing information to the scheduler which enables much more flexibility and allows for maximum scheduling gain. For less delay sensitive services a UE could be instructed to flush the HARQ process buffer immediately after the initial transmission failure to maximally simplify the implementation and at the same time preserve the scheduling gains.

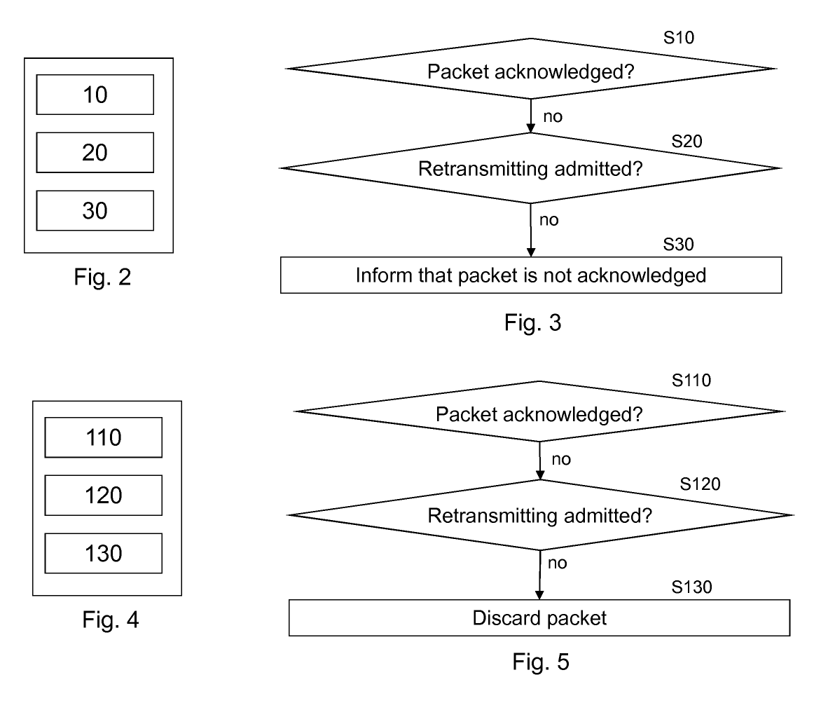

FIG. 2 shows an apparatus according to an embodiment of the invention. The apparatus may be a sender of a packet, and in particular a terminal such as a UE or an element thereof. FIG. 3 shows a method according to an embodiment of the invention. The apparatus according to FIG. 2 may perform the method of FIG. 3 but is not limited to this method. The method of FIG. 3 may be performed by the apparatus of FIG. 2 but is not limited to being performed by this apparatus.

The apparatus comprises monitoring means 10, checking means 20, and informing means 30.

The monitoring means 10 monitors if a sent packet is acknowledged as correctly received (S10). If the sent packet is not acknowledged as correctly received (S10=“no”), the checking means 20 checks if retransmitting the sent packet at a time interval determined for retransmission is admitted (S20). If the retransmitting at the determined time interval is not admitted (S20=“no”), the informing means 30 informs that the sent packet is not acknowledged as correctly received (S30). E.g., the informing means may inform by signaling such as signaling SI.

FIG. 4 shows an apparatus according to an embodiment of the invention. The apparatus may be a sender of a packet, and in particular a terminal such as a UE or an element thereof. FIG. 5 shows a method according to an embodiment of the invention. The apparatus according to FIG. 4 may perform the method of FIG. 5 but is not limited to this method. The method of FIG. 5 may be performed by the apparatus of FIG. 4 but is not limited to being performed by this apparatus.

The apparatus comprises monitoring means 110, checking means 120, and discarding means 130.

The monitoring means 110 monitors if a sent packet is acknowledged as correctly received (S110). If the sent packet is not acknowledged as correctly received (S110=“no”), the checking means 120 checks if retransmitting the sent packet at a time interval determined for retransmission is admitted (S120). If the retransmitting at the determined time interval is not admitted (S120=“no”), the discarding means 130 discards the packet (S130). The discarding means 130 may discard the packet irrespective of an actual number of retransmissions of the packet. E.g., the discarding means 130 may set a number of retransmissions of the sent packet to a predefined maximum number irrespective of the actual number of retransmissions. The actual number of retransmissions indicates how often the packet has been retransmitted yet. The maximum number is a natural number of 1, 2, 3, or more. In addition, the apparatus may flush (empty) a buffer in which the sent packet is stored.

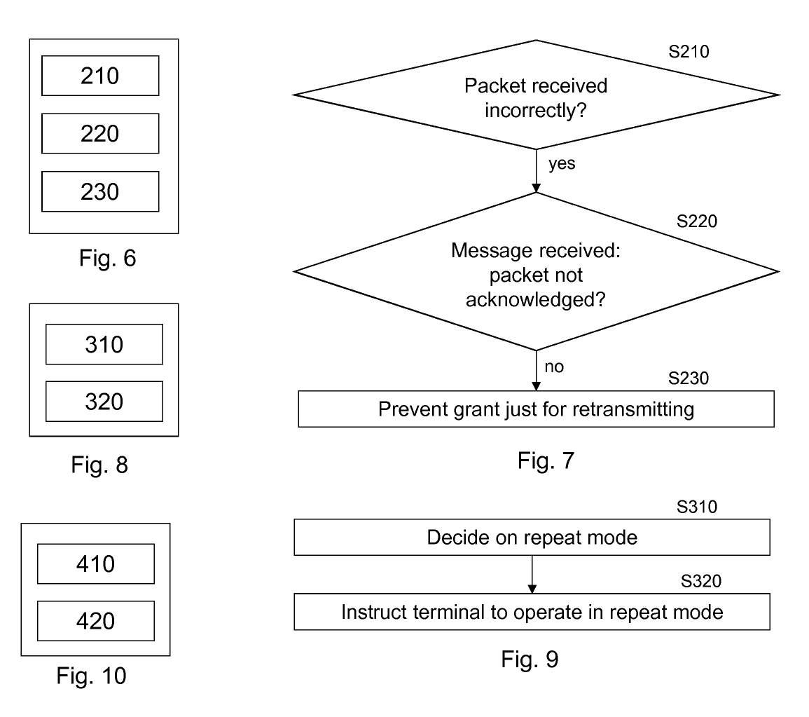

FIG. 6 shows an apparatus according to an embodiment of the invention. The apparatus may be a base station such as a NB, an eNB or an element thereof. In particular, it may be a serving Base station. FIG. 7 shows a method according to an embodiment of the invention. The apparatus according to FIG. 6 may perform the method of FIG. 7 but is not limited to this method. The method of FIG. 7 may be performed by the apparatus of FIG. 6 but is not limited to being performed by this apparatus.

The apparatus comprises monitoring means 210, checking means 220, and preventing means 230.

The monitoring means 210 monitors if a packet from a sender was received incorrectly (S210). If the packet was received incorrectly (S210=“yes”), the checking means 220 checks if a message is received that the packet is not acknowledged as to be correctly received (S220). If the message is not received (S220=“no”), the preventing means 230 prevents a granting means from granting a time interval to the sender just for retransmitting the packet (S230). I.e., if the granting means will grant the time interval anyway to the sender for other reasons than retransmitting, it is not prevented from granting, but if the granting means does not intend to grant the time interval to the sender for other reasons, it will not grant the time interval for retransmission if the message is not received.

FIG. 8 shows an apparatus according to an embodiment of the invention. The apparatus may be a controller such as a RNC or an element thereof. FIG. 9 shows a method according to an embodiment of the invention. The apparatus according to FIG. 8 may perform the method of FIG. 9 but is not limited to this method. The method of FIG. 9 may be performed by the apparatus of FIG. 8 but is not limited to being performed by this apparatus.

The apparatus comprises deciding means 310, and instructing means 320.

The deciding means 310 decides on a repeat mode a terminal has to perform for a sent packet for which the terminal does not receive an acknowledgement (S310). The repeat mode is selected out of a group of repeat modes. A repeat mode may be a HARQ mode. The group of repeat modes comprises at least two of
retransmitting the packet at a predetermined time interval irrespective of whether the predetermined time interval is granted to the terminal (conventional HARQ mode),
informing a base station that the acknowledgement was not received (HARQ mode, as described in 1) hereinabove), and
discarding the packet (HARQ mode as described in 2) hereinabove).

The instructing means 320 instructs the terminal to perform the decided repeat mode (S320). In addition, in some embodiments, the apparatus may inform a base station (serving base station of the terminal) on the decided repeat mode (HARQ mode).

FIG. 10 shows an apparatus according to an embodiment of the invention. The apparatus comprises at least one processor 410, at least one memory 420 including computer program code, and the at least one processor, with the at least one memory and the computer program code, being arranged to cause the apparatus to at least perform at least one of the methods according to FIGS. 3, 5, 7, and 9.

The time for retransmission may be determined as a fixed (predetermined) time after the initial transmission. However, in some embodiments of the invention, the time for retransmission may be determined based on other conditions such as network load etc. In these embodiments, the rule to determine the time for retransmission is predetermined and is known to both base station and UE.

Embodiments of the invention may be employed in a 3GPP network. They may be employed also in other mobile networks such as CDMA, EDGE, UMTS, LTE, LTE-A, WiFi networks, etc. In particular, they may be employed when HARQ is applied in a transmission from a sender to a receiver, and the receiver is responsible for scheduling resources to the sender.

A terminal may be a user equipment such as a mobile phone, a smart phone, a PDA, a laptop, a tablet PC, or any other device which may be connected to the respective mobile network. A base station may be a base station of the corresponding technology such as a NodeB, an eNodeB, an Access Point etc.

One piece of information may be transmitted in one or plural messages from one entity to another entity. Each of these messages may comprise further (different) pieces of information.

Names of network elements, protocols, and methods are based on current standards. In other versions or other technologies, the names of these network elements and/or protocols and/or methods may be different, as long as they provide a corresponding functionality.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software.

According to the above description, it should thus be apparent that exemplary embodiments of the present invention provide, for example a base station such as a NB, an eNB, or a component thereof, an apparatus embodying the same, a method for controlling and/or operating the same, and computer program(s) controlling and/or operating the same as well as mediums carrying such computer program(s) and forming computer program product(s). Furthermore, according to the above description, it should thus be apparent that exemplary embodiments of the present invention provide, for example a terminal such as a UE or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1-44. (canceled)

45. An apparatus comprising
at least one processor, and
at least one memory for storing instructions to be executed by the processor, wherein
the at least one memory and the instructions are configured to, with the at least one processor, cause the apparatus at least to
monitor if a sent packet is acknowledged as correctly received;
check, if the sent packet is not acknowledged as correctly received, if retransmitting the sent packet at a time interval determined for retransmission is admitted; and
at least one of:
inform, if the retransmitting at the determined time interval is not admitted, that the sent packet is not acknowledged as correctly received;
prevent retransmission of the sent packet at the determined time interval if the retransmission at the determined time interval is not admitted.

46. The apparatus according to claim 46, further configured to cause the apparatus to inform by signaling scheduling information.

47. The apparatus according to claim 47, further configured to cause the apparatus to set, if the retransmitting at the determined time interval is not admitted, a number of retransmissions of the sent packet to a predefined maximum number.

48. The apparatus according to claim 48, further configured to cause the apparatus to flush a buffer in which the sent packet is stored.

49. The apparatus according to claim 49, further configured to cause the apparatus to:
instruct the apparatus, if the sent packet is not acknowledged as correctly received to retransmit the sent packet;
determine if a condition is established;
inhibit the preventing if the condition is not established and to inhibit the instructing if the condition is established.

50. The apparatus according to claim 49, wherein the condition comprises that an instruction is received to inhibit the apparatus from instructing.

51. The apparatus according to claim 49, wherein the condition comprises that the apparatus is in a soft handover process.

52. An apparatus comprising
at least one processor, and
at least one memory for storing instructions to be executed by the processor, wherein
the at least one memory and the instructions are configured to, with the at least one processor, cause the apparatus at least to
monitor if a sent packet is acknowledged as correctly received;
check, if the sent packet is not acknowledged as correctly received, if retransmitting the sent packet at a time interval determined for retransmission is admitted;
discard the packet if the retransmitting at the determined time interval is not admitted irrespective of an actual number of retransmissions of the sent packet.

53. The apparatus according to claim 52, further configured to cause the apparatus to inform by signaling scheduling information.

54. The apparatus according to claim 52, further configured to cause the apparatus to set, if the retransmitting at the determined time interval is not admitted, a number of retransmissions of the sent packet to a predefined maximum number.

55. The apparatus according to claim 52, further configured to cause the apparatus to flush a buffer in which the sent packet is stored.

56. The apparatus according to claim 52, further configured to cause the apparatus to prevent retransmitting the sent packet at the determined time interval if the retransmitting at the determined time interval is not admitted.

57. The apparatus according to claim 56, further configured to cause the apparatus to:
instruct the apparatus, if the sent packet is not acknowledged as correctly received to retransmit the sent packet;
determine if a condition is established;
inhibit the preventing if the condition is not established and to inhibit the instructing if the condition is established.

58. The apparatus according to claim 57, wherein the condition comprises that an instruction is received to inhibit the apparatus from instructing.

59. The apparatus according to claim 57, wherein the condition comprises that the apparatus is in a soft handover process.

60. An apparatus comprising
at least one processor, and
at least one memory for storing instructions to be executed by the processor, wherein
the at least one memory and the instructions are configured to, with the at least one processor, cause the apparatus at least to
decide on a repeat mode out of a group of repeat modes a terminal has to perform for a sent packet for which the terminal does not receive an acknowledgment, wherein the group of repeat modes comprises at least two of:
retransmitting the packet at a predetermined time interval irrespective of whether the predetermined time interval is granted to the terminal,
informing a base station that the acknowledgment was not received, and
discarding the packet; and
instruct the terminal to perform the decided repeat mode.

61. The apparatus according to claim 60, further configured to cause the apparatus to inform the base station on the decided repeat mode.

62. The apparatus according to claim 60, wherein decide on a repeat mode comprises decide on a repeat mode based on at least one of a handover status of the terminal, a service type used by the terminal, a cell throughput of the base station, and a transmission delay between the terminal and the base station.
